(19) United States
(12) Patent Application Publication
(10) Pub. No.: US 2013/0078866 A1
(43) Pub. Date: Mar. 28, 2013

(54) ELECTRICAL CONNECTOR

(71) Applicants: Yu-hung Su, New Taipei (TW); Yao-ting Wang, New Taipei (TW)

(72) Inventors: Yu-hung Su, New Taipei (TW); Yao-ting Wang, New Taipei (TW)

(73) Assignee: Cheng Uei Precision Industry Co., Ltd., New Taipei City (TW)

(21) Appl. No.: 13/244,334

(22) Filed: Sep. 24, 2011

(51) Int. Cl. H01R 24/28

(52) U.S. Cl. 439/660

(57) ABSTRACT

Disclosed is an electrical connector, which includes an insulative body, a plurality of terminals, and a case. Terminal slots are defined in the insulative body. The terminals are respectively disposed in the terminal slots. The terminals includes a grounding terminal, a power terminal, and a plurality of signal terminals, such that each of the grounding, the power, and the signal terminals has a base arm, a contacting arm, and a welding arm, wherein heights of the contacting arms of the grounding terminal, the power terminal, and the signal terminals are gradually descending to form differences of the heights. Because the heights of the contacting arms are designed to gradually descend, the main control circuit inside a navigator can be better protected, and a more stable signal transmission can be ensured.

### FIELD OF THE INVENTION

The present invention relates to a connector, and especially to an electrical connector used in a navigator.

### BACKGROUND OF THE INVENTION

GPS (Global Positioning System) navigations are configured in navigators for vehicles have been widely known. With the rapid development of science and technology, the navigator is developed in directions of a compact size, multi functions, user-friendly technology. Electrical connectors that are utilized to connect a main control circuit inside the navigators to components of external wireless transmission circuits play a significant role in the developing processes of the multi functions. The electrical connector that is disposed in a conventional navigator includes an insulative body, a plurality of terminals, and a case, and so on. The terminals specifically include a grounding terminal, a power terminal, and a plurality of signal terminals. The electrical transmission and data transmission between the wireless transmission circuits and the navigator are realized by means of the power terminal and the signal terminals being coupled to corresponding components of the wireless transmission circuit, and a conduction of grounding terminal provides a protective function for the main control circuit inside the navigator.

However, the grounding terminal, power terminal and signal terminals of the conventional electrical connector are connected and disconnected with the external wireless transmission circuit without difference in orders thereof. Due to manufacturing and installation errors, when the navigator is coupled to the external wireless transmission circuit, the power terminal may couple to the external wireless transmission circuit at first, and then the grounding terminal and the signal terminals are conducted. Accordingly, in a duration between the conduction of the power terminal and the conduction of the grounding terminal, the main control circuit inside the navigator has no correspond leakage protection. In a case disconnecting the navigator and the external wireless transmission circuit, the grounding terminal, power terminal and signal terminals are disconnected simultaneously. This situation may cause that a power source has been disconnected before signals are transmitted completely, resulting in incomplete signal transmission. Also, the grounding terminal may be disconnected at first, so that the main control circuit inside the navigator has no correspond leakage protection.

### SUMMARY OF THE INVENTION

An objective of the present invention is to provide an electrical connector being capable of protecting the main control circuit inside the navigator better and ensuring a more stable signal transmission.

To achieve the foregoing objectives, according to an aspect of the present invention, an electrical connector provided by the present invention is mounted on a navigator for connecting the navigator to an external transmission circuit. The electrical connector includes an insulative body, a plurality of terminals, and a case. A plurality of terminal slots is defined in the insulative body. The terminals are respectively disposed in the terminal slots. Each of the terminals includes a grounding terminal, a power terminal, and a plurality of signal terminals, such that each of the grounding, the power, and the signal terminals has a base arm, a contacting arm, and a welding arm. Heights of the contacting arms of the grounding terminal, the power terminal, and the signal terminals are gradually descending to form differences of the heights. The case has a seat body which has a receiving recess upwardly penetrating an upper surface of the seat body, and the insulative body is received in the receiving recess.

As mentioned above, the heights of the grounding terminal, power terminal, and signal terminals of the electrical connector of the present invention are designed to gradually descend, thus making the main control circuit inside the navigator to be better protected and a more stable signal transmission is ensured.

### BRIEF DESCRIPTION OF THE DRAWINGS

FIG. 1 is a perspective view illustrating a connector according to of the present invention;

FIG. 2 is an exploded view illustrating the connector of FIG. 1;

FIG. 3 is a perspective view illustrating an insulative body of the connector of FIG. 1 in another angle;

FIG. 4 is a perspective view illustrating terminals of the connector of FIG. 1 in another angle;

FIG. 5 is a assembly schematic drawing illustrating the insulative body and the terminals of the connector of FIG. 1; and

FIG. 6 is a right side view illustrating partial assemble of the connector of FIG. 2.

### DETAILED DESCRIPTION OF THE PREFERRED EMBODIMENTS

Reference will now be made in detail to a preferred embodiment of the invention, examples of which are illustrated in the accompanying drawings.

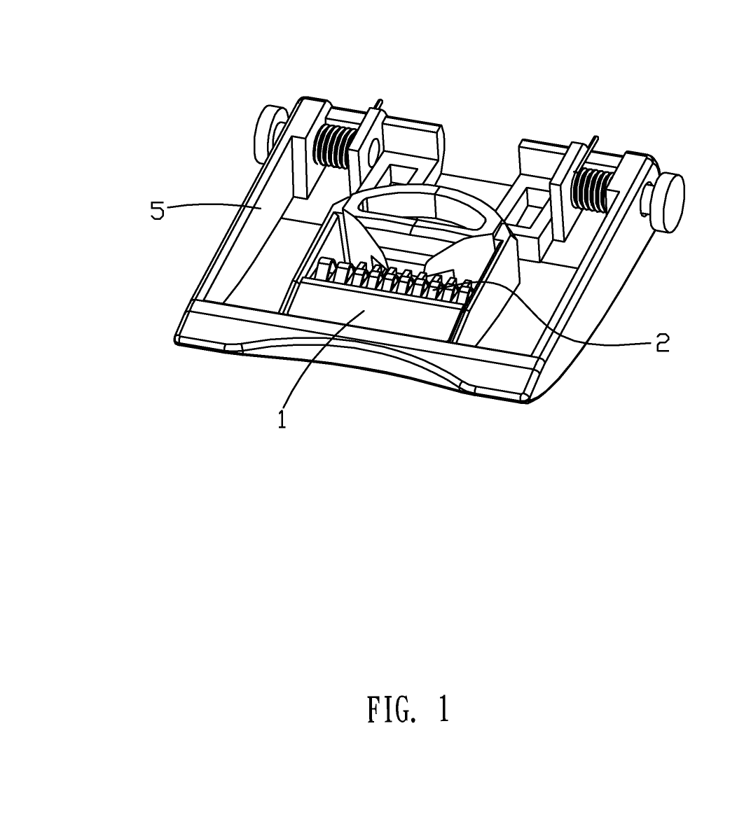

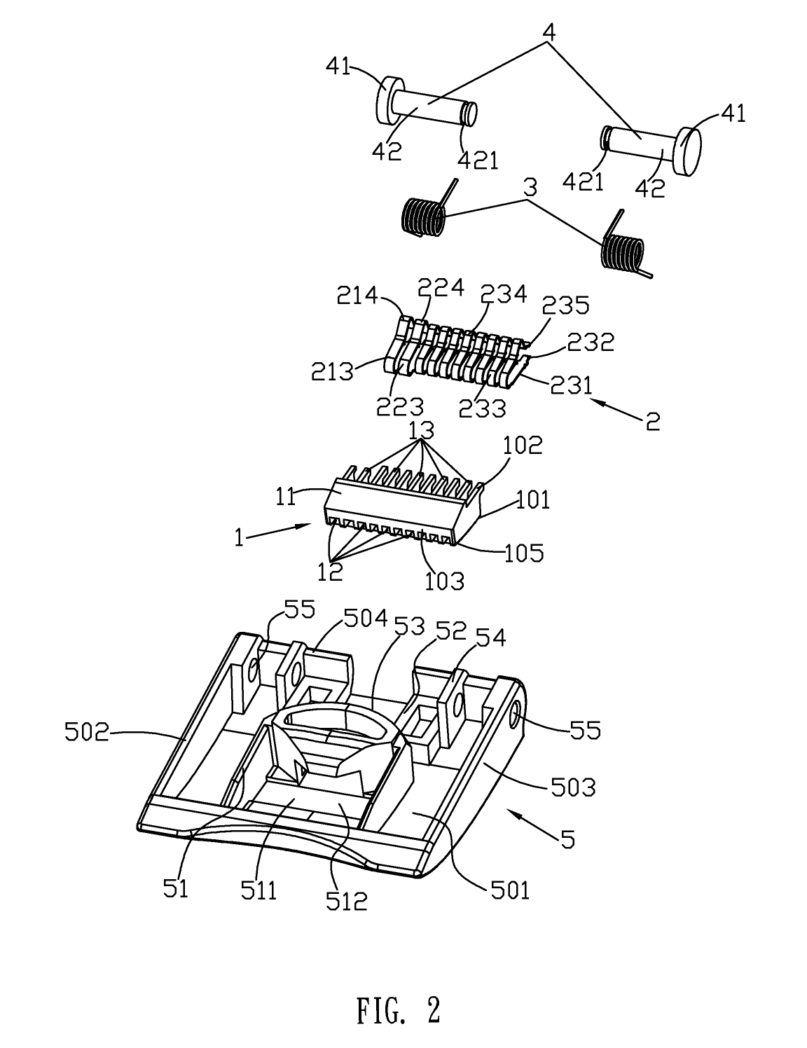

Referring to FIG. 1 and FIG. 2, the electrical connector of the present invention includes an insulative body 1, a plurality of terminals 2, two springs 3, two shafts 4, and a case 5.

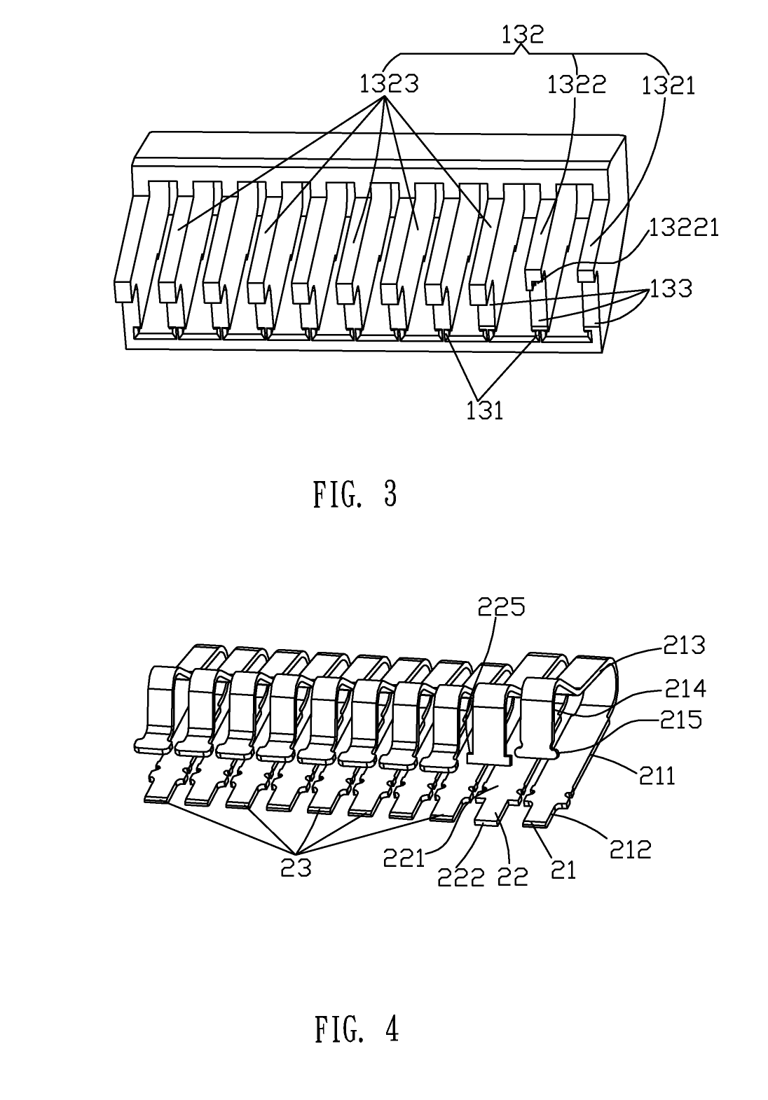

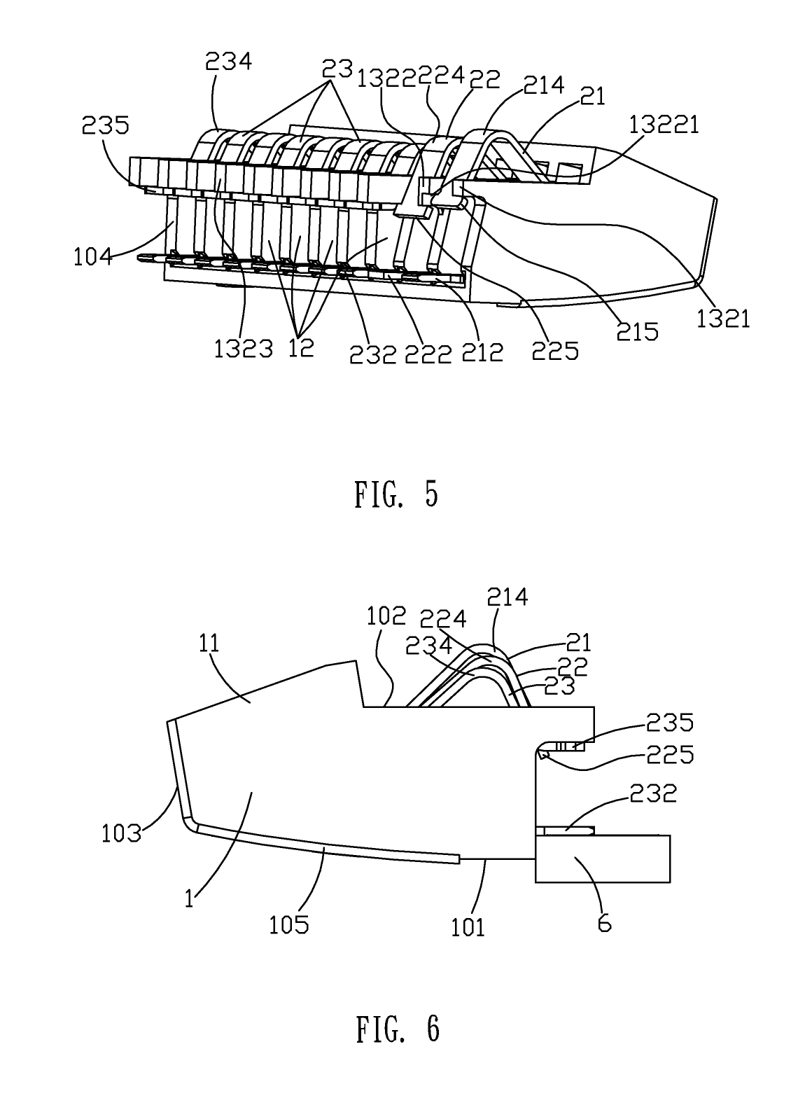

Referring to FIG. 2, FIG. 3, FIG. 5, and FIG. 6, the insulative body 1 has a bottom wall 101, a top wall 102, a front wall 103 tilting backwardly downward, a rear wall 104, and a connecting wall 105 which is coupled to the bottom wall 101 and the front wall 103 and tilts backwardly downward. A convex platform 11 coupling to the top wall 102 and the front wall 103 protrudes upward from a front of the top wall 102, and an upper surface of the convex platform 11 tilts upwards and backwards. A plurality of terminal slots 12 penetrate through the insulative body 1 from a bottom of the front wall 103 to the top wall 102, the rear wall 104, and a back surface of the convex platform 11. The terminal slots 12 are defined in the insulative body 1 so that a plurality of separators 13 is formed on the insulative body 1. A lower end of a back side of every separator 13 forms two chamfers 131 respectively at two slot walls of the two adjacent terminal slots 12. A plurality of strips 132 is protruded backwards from tops of the separators 13, and the strips 132 includes a first strip 1321, a second strip 1322, and third strips 1323 from left to right. The first, second, and third strips at a bottom of the rear wall 104 define a plurality of inclined parts 133 tilting forwards and upwards, so that lengths of the first strip 1321 and the second strip 1322 are shorter than the third strips 1323, and thickness of the first strip 1321 are less than the second strip 1322 and the third strip 1323. An engaging slit 13221 is defined on a back surface of the second strip 1322.

Referring to FIG. 2, FIG. 4, FIG. 5, and FIG. 6, The terminals 2 are disposed in the terminal slots 12, and the terminals includes a grounding terminal 21, a power terminal 22, and a plurality of signal terminals 23. The grounding terminal 21 includes an elongated base arm 211, a welding arm 212 formed by extending horizontally form an end of the base arm 211, a connecting arm 213 formed by extending and bending upwards from an opposite end of the base arm 211 and then extending to the base arm 211, a contacting arm 214 formed as an arc by extending and bending upwards and then extending and bending downwards from an end of the connecting arm 213, and a holding arm 215 is formed by protruding at both sides of an end of the contacting arm 214. Shape and structure of the power terminal 22 are identical to the grounding terminal 21, and the power terminal 22 includes a base arm 221, a welding arm 222, a connecting arm 223, a contacting arm 224, and a holding arm 225. Shape and structure of the signal terminal 23 are same to the grounding terminal 21 and power terminal 22, and the signal terminal 23 includes a base arm 231, a welding arm 232, a connecting arm 233, a contacting arm 234, and a holding arm 235, in which one difference from those arms is that the holding arm 235 of the signal terminals 23 is formed by extending horizontally form the end of the contacting arm 234. In addition, the contacting arm 214 of the grounding terminal 21 and the contacting arm 224 of the power terminal 22 have a difference of height, as well as the contacting arm 224 of the power terminal 22 and the contacting arm 234 of the signal terminal 23 have a difference of height through compressing in advance. Moreover, an order of the heights thereof from high to low are the contacting arm 214 of the grounding terminal 21, the contacting arm 224 of the power terminal 22, and the contacting arm 234 of the signal terminal 23. The welding arms 212, 222, 232 of each of the terminals are located on an identical horizontal plane.

Referring to FIG. 1 and FIG. 2, the two shafts 4 are mounted on the rear of the case 5, and each shaft 4 has a circular base portion 41 and a shaft portion 42 protruding from a middle of a side of the base portion 41. A groove 421 is defined in an end of the shaft portion 42.

Referring to FIG. 1 and FIG. 2, the case 5 has a bottom plate 501 tilting backwardly downward, a left side plate 502, a right side plate 503, and a rear plate 504. A seat body 51 protrudes upwards from a middle of the front of the bottom plate 501. The seat body 51 has a receiving recess 511 upwardly penetrating an upper surface of the seat body 51 for receiving the insulative body 1. A receiving slot 512 which is interconnect with the receiving recess 511 is defined in a bottom wall on a rear of the receiving recess 511 for receiving a circuit board 6 (as shown in FIG. 6). A bearing platform 52, which is coupled to the seat body 51 and the rear plate 504, protrudes upwards from the rear of the bottom plate 501. A channel 53, which is interconnecting with the receiving recess 511 and penetrates bearing platform 52 and the rear plate 504, is defined forwards in a lower end of a middle of the rear plate 504. Two connecting plate 54 protrude forward from a front surface of the rear plate 54 at a right side and a left side of the bearing platform 52. A connecting hole 55 defined in each of side surfaces of the left side plate 502, the right side plate 503 and the connecting plate 54 for interconnecting to each other.

Referring to FIG. 1, FIG. 5, and FIG. 6, in assembling the connector of the present invention, the grounding terminal 21, the power terminal 22, and the signal terminals 23 of the terminals 2 from left to right are parallel inserted into the terminal slots 12 in sequence from the rear wall 104 of the insulative body 1. The welding arms 215, 225, and 235 of the terminals 2 protrude backwards out of the insulative body 1 for being welded to the circuit board 6. The connecting arms 213, 223, and 233 are received in the front of the terminal slots 12, and the connecting arms 213, 223, and 233 protrude out of the top wall 102 of the insulative body 1. The holding arm 215 of the grounding terminal 21 is held at the lower surface of the first strip 1321 and at a left side wall of the engaging slit 13221 of the second strip 1322. The holding arm 225 of the power terminal 22 is held at the right lower surface of the second strip 1322 and at the lower surface of the adjacent third strip 1323. The holding arms 235 of the signal terminal 23 are held at two lower surfaces of the remaining two adjacent third strips 1323. Then the welding arms 215, 225, and 235 of the terminals 2 are welded on the circuit board 6, and the insulative body 1 welded with the circuit board 6 is received in the receiving recess 511 and the receiving slot 512. Finally, the two springs 3 are respectively fitted over the shaft portions 42 of the two shafts 4, and the shaft portion 42 of the shaft 4 penetrate the connecting hole 55 to couple to the case 5 rotatably, so as to connect the connector of the present invention to the navigator.

In operating the electrical connector of the present invention, the external wireless transmission circuit is coupled to the electrical connector of the present invention via a complementary connector mounted thereon. Specifically, complementary terminals of the complementary connector are in contact with the conductive terminals 2 of the present invention from top to down. Because contacting portions of the complementary terminals are parallel disposed, and the heights of the contacting arms of the grounding terminal 21, power terminal 22, and signal terminals 23 of the terminals 2 gradually descend, the grounding terminal 21 touches the external wireless transmission circuit at first for forming the leakage protection. Then the power terminal 22 is coupled to the external wireless transmission circuit to transmit power to the main control circuit inside the navigator. Finally, the signal terminals 23 are coupled to the external wireless transmission circuit to realize the signal transmission. Therefore, the main control circuit inside the navigator can be protected before the power is connected, so that the leakage protection of the main control circuit inside the navigator continues throughout the connecting process. Similarly, when disconnecting the external wireless transmission circuit and the navigator, an order of disconnecting the terminals 2 is the signal terminals 23 firstly, the power terminal 22 secondly, and the grounding terminal 21 finally. Therefore, it can be avoided that the power is disconnected before transmitting signal completely, and the grounding terminal 21 is disconnected finally, so that the leakage protection of the main control circuit inside the navigator continues throughout the disconnecting process.

As mentioned above, the heights of the grounding terminal 21, power terminal 22, and signal terminals 23 of the electrical connector of the present invention are designed to gradually descend, thus making the main control circuit inside the navigator to be better protected and a more stable signal transmission is ensured.

What is claimed is:

1. An electrical connector mounted to a navigator for connecting the navigator to an external transmission circuit, comprising:
an insulative body defining a plurality of terminal slots thereon;
a plurality of terminals disposed in the terminal slots, the terminals comprising a grounding terminal, a power terminal, and a plurality of signal terminals, each of the grounding terminal, the power terminal, and the signal terminals has a base arm, a contacting arm, and a welding arm, wherein heights of the contacting arms are gradually descending to form differences of the heights; and
a case having a seat body having a receiving recess upwardly penetrating an upper surface of the seat body, the insulative body being received in the receiving recess.

2. The electrical connector of claim 1, wherein the insulative body has a bottom wall, a top wall, a front wall tilting backwardly downward, a rear wall, and a connecting wall which is coupled to the bottom wall and the front wall as well as tilting backwardly downward, wherein the terminal slots penetrate through the insulative body from a bottom of the front wall to the top wall and the rear wall.

3. The electrical connector of claim 1, wherein a plurality of separators are formed on the insulative body, and a plurality of strips protrude backwards from tops of the separators, the strips comprise a first strip, a second strip, and third strips from left to right, and the first strip, the second strip are shorter than the third strips, and the second strip, the third strip are thicker than the first strip, and a back surface of the second strip has an engaging slit defined thereon.

4. The electrical connector of claim 3, wherein each of the power terminal, the signal terminals, and the grounding terminals comprises a base arm, a welding arm formed by extending horizontally from an end of the base arm, a connecting arm formed by extending and bending upwards from an opposite end of the base arm, a contacting arm formed as an arc by extending and bending upwards and then extending and bending downwards from an end of the connecting arm, and a holding arm formed by protruding at both sides of an end of the contacting arm.

5. The electrical connector of claim 4, wherein the holding arms of the signal terminals are formed by extending horizontally from the end of the contacting arm.

6. The electrical connector of claim 4, wherein the welding arms are located at an identical horizontal plane, and protrude out of the insulative body for being welded to an circuit board.

7. The electrical connector of claim 1, wherein a receiving slot which is interconnect with the receiving recess is defined in a bottom wall on a rear of the receiving recess, and a circuit board is received in the receiving slot.

8. The electrical connector of claim 1, further comprising two shafts, each shaft having a base portion and a shaft portion protruding from a middle of a side of the base portion, a groove defined in an end of the shaft portion, wherein the case has a bottom plate tilting backwardly downward, a left side plate, a right side plate, and a rear plate, two connecting plate protruding onward from a front surface of the rear plate, a connecting hole defined in each of side surfaces of the left side plate, the right side plate, and the connecting plate for interconnecting to each other, the shaft portion penetrating the connecting hole to couple to the case rotatably.
